(19) United States
(12) Patent Application Publication
(10) Pub. No.: US 2025/0289148 A1
(43) Pub. Date: Sep. 18, 2025

(54) SUCTION CUP FOR A HANDLING DEVICE

(71) Applicant: Festo SE & Co. KG, Esslingen (DE)

(72) Inventors: Henrico VAN ZUILEN, CK Middelbeers (NL); Nadine MEINING, Esslingen (DE); Dominik SCHUBERT, Ebersbach (DE)

(21) Appl. No.: 19/074,913

(22) Filed: Mar. 10, 2025

(30) Foreign Application Priority Data
Mar. 12, 2024 (DE) 10 2024 106 984.8

(51) Int. Cl. B25J 15/06

(52) U.S. Cl. CPC B25J 15/0683

(57) ABSTRACT

Suction cup for a handling device, with a suction bowl which is provided with a vacuum connection at a bowl bottom and which is connected to an intermediate ring at a bowl mouth, the intermediate ring being provided with a carrier ring and the carrier ring being provided at an axial end region, which faces away from the intermediate ring, with a sealing ring, which is configured for a sealing abutment on a handling object.

### CROSS REFERENCE TO RELATED APPLICATION

The present application claims the benefit of German application DE 102024106984.8, filed Mar. 12, 2024, which is incorporated herein by reference.

### BACKGROUND OF THE INVENTION

The invention relates to a suction cup for a handling device.

DE 10 2013 009 344 A1 discloses a suction gripper for holding flexible objects by means of suction, the suction gripper having suction recesses which have a working opening on a front side and which are separated by an air-permeable suction wall from a suction chamber that can be subjected to negative pressure, and a multiplicity of suction channels passing through the suction wall, open out at an intake surface of the intake wall facing the suction recess with intake openings, and the intake surface is concave in shape so that the intake openings are arranged in three-dimensional distribution around the suction recess.

DE 40 40 570 A1 discloses a suction pick-up device with a housing which has a suction-air connection and one at least partly open housing side, wherein a seal surrounds the opening(s) of the housing-side and is made of soft-elastic foam which has partly open cells, in the form of a plate and wherein grid or sieve type supports are positioned in the holes on the housing side and act as stops for the foam plate being sucked into the interior of the housing such that the suction pick-up device can be used for smooth or uneven surfaces of objects, particularly cylindrical objects of different diameters.

DE 198 17 323 A1 discloses a grab with a suction plate having an elastic sealing lip and connected to an underpressure source wherein the suction plate is fastened to a connector via a joint with an elastic body, which is non-turnably connected to connector and grab and wherein a suction channel extends through connector, elastic body, and suction plate, wherein the connector is formed as a flanged sleeve and is screw-fastened to a lifting device and the elastic body consists of an elastomer material, e.g. rubber, and has an integrated webbing insert.

### SUMMARY OF THE INVENTION

The object of the invention is to provide a suction cup that can be flexibly adapted to different operating conditions.

This problem is solved for a suction cup of the type mentioned above by the suction cup having a suction bowl which is provided with a vacuum connection at a bowl bottom and which is connected to an intermediate ring at a bowl mouth, the intermediate ring being provided with a carrier ring at an axial end region which faces away from the suction bowl, is provided with a carrier ring and, at an axial end region which faces away from the intermediate ring, the carrier ring is provided with a sealing ring which is designed for sealing contact with a handling object.

The suction bowl can have a flat or bowl-shaped bowl bottom, on which a vacuum connection is formed, which vacuum connection can have a dual function: on the one hand, to provide a vacuum to the suction bowl and, on the other hand, to serve as a mechanical interface for coupling to a handling device, for example a wrist axis of an industrial robot. Preferably, the vacuum connection is designed as a substantially circular-cylindrical nozzle, which is penetrated by a fluid bore and can be provided with a thread on an inner surface and/or on an outer surface. A sleeve-shaped bowl wall, in particular one with a circular ring-shaped profile, adjoins the bottom of the cup in an axial direction, with an end region of the bowl wall facing away from the bottom of the cup defining a cup opening. The axial direction can be identical with an axis of rotational symmetry of the bowl wall in the case of a circular cylindrical bowl wall or with an axis of projection in the case of a non-circular cylindrical bowl wall.

This cup opening is intended for connection to an intermediate ring, this connection preferably being designed to be force-locking and/or form-fitting. The intermediate ring serves as a coupling part between the suction bowl and a carrier ring, which in turn is fixed to an axial end region of the intermediate ring that faces away from the suction bowl. The connection between the intermediate ring and the carrier ring is preferably realized with a non-positive-fit connection or force-fit connection and/or with a positive-fit connection. A sealing ring is arranged on an axial end region of the carrier ring that faces away from the intermediate ring, which sealing ring is designed to fit sealingly against a handling object.

This handling object can be, for example, a workpiece that has to be transported from one processing step to the next. The handling object can also be a food item such as an apple or an orange, which can be gently lifted and set down with the help of the suction cup. The handling object to be handled can also be a plastic bag, which can be lifted and set down again with the help of the suction cup without damaging the film web from which the plastic bag is made.

The modular design of the suction cup allows the sealing ring to be adapted to the particular application for which the suction cup is intended. For example, a sealing ring with low elasticity can be used for handling a plastic bag, while a sealing ring with high elasticity can be used for handling a food product to avoid pressure marks.

Advantageous further developments of the invention are the subject of the sub-claims.

It is advantageous if a plurality of vacuum channels are formed on an inner surface of the bottom of the suction bowl, which channels are connected in fluid communication to a connection bore of the vacuum connection and are bounded by a multiplicity of projections that are arranged at a distance from one another and project in the axial direction. The aim of the vacuum channels is to apply a vacuum as homogeneously as possible to the handling object, whereby the vacuum channels should be distributed as evenly as possible over the inner surface of the base of the cup. The vacuum channels are preferably designed to be completely open in the direction of the cup opening, which facilitates the production of the suction bowl using the plastic injection molding process. The vacuum channels are bound by projections that are arranged at a distance from one another and project in the axial direction, which may be designed, for example, in the form of blades or pegs. In particular the projections may be formed as rods which are oriented in parallel to each other. Preferably the rods are cylindrical, in particular the rods have a circular cross section. All of the vacuum channels may extend from the fluid bore of the vacuum connection or may be designed as a multiply branched channel arrangement.

It is preferably provided that the suction bowl has a first interface at a bowl mouth and that the intermediate ring is provided with a second interface and with a third interface at opposite axial end regions, the second interface being designed for coupling to the first interface of the suction bowl, and that the carrier ring is provided with a fourth interface at one axial end region, which is designed for coupling with the third interface of the intermediate ring. Preferably, the first, second, third fourth) interfaces are each designed for a fluid-tight connection between suction bowl and intermediate ring or intermediate ring and carrier ring, in order to prevent infiltration of false air into a suction space bounded by the suction cup, wherein the suction space is to be closed during the intended use of the suction cup by the handling object resting against the sealing ring. To be able to guarantee these properties for the interfaces, the corresponding interfaces may have inner and outer surfaces that rest against each other in a flat manner, which can be designed in particular in the shape of a cylinder jacket or cone jacket. By a peripheral abutment of the corresponding interfaces, a sealing effect sufficient for many applications can be achieved without additional sealing means, in particular if the interfaces are geometrically similar, with suitable dimensioning, especially if the suction cup is used to lift and set down rather sensitive objects such as food or plastic bags.

It is advantageous if the first interface and the second interface and/or the third interface and the fourth interface form a form-fitting connection from the group: latching connection having a latching groove that runs around it at least in some areas and is recessed in the radial direction and having a latching projection that runs around it at least in some areas and projects in the radial direction, and a bayonet connection having an axial undercut and a supporting projection designed for axial support on the axial undercut. With regard to the form-locking effect between the respective interfaces, it is assumed that the form-locking is effective in the direction of a bowl axis which extends from the bowl bottom in the direction of the bowl mouth and, in the case of a rotationally symmetrical design of the suction bowl, also corresponds to the axis of rotational symmetry.

The form-fitting connection can be designed as a snap-in connection for one or both of the interface combinations, in which a purely linear movement between the suction bowl and intermediate ring and/or between the carrier ring and intermediate ring is sufficient to effect the form fit. In this case, it is envisaged that a latching groove, which is at least partially continuous and recessed in the radial direction, is formed on one of the two interfaces, and a latching projection, which is at least partially continuous and extends in the radial direction, is formed on the other interface and can engage in the latching groove. It is preferably provided that the latching groove and the latching projection are formed rotationally symmetrically around the respective interface, so that no rotational orientation between the interfaces to be connected is to be taken into account.

If the form-fit connection is designed as a bayonet connection for one or both interface pairings, a predetermined sequence of movements between the two interfaces must be observed in order to achieve the desired coupling of the interfaces to be connected. It is preferably envisaged that for the coupling process, a linear approach movement is first made between the two interfaces along the bowl axis until the two interfaces overlap mechanically, in order to then achieve the desired coupling by means of a rotational relative movement between the two interfaces about the bowl axis. For this coupling, one of the two interfaces has an axial undercut, which has a surface normal that is aligned at least essentially parallel to the bowl axis. The other interface has a supporting projection that is designed to rest on the surface provided by the axial undercut and thereby enables a force transmission between the two interfaces in the direction of the bowl axis, without an undesired linear movement occurring between the two interfaces.

In a further embodiment of the invention, it is provided that the suction bowl has a first interface at a bowl mouth, that the intermediate ring is received between the suction bowl and the carrier ring and that the carrier ring is provided at an axial end region with a fourth interface which is designed for coupling to the first interface of the suction bowl, the first interface and the fourth interface forming a form-locking connection from the group: a latching connection having a latching groove which runs around the periphery, at least in some areas, and is recessed in the radial direction, and having a latching projection which runs around the periphery, at least in some areas, and projects in the radial direction, and a bayonet connection having an axial undercut and a supporting projection designed for axial support on the axial undercut. In this embodiment of the suction cup, the intermediate ring is received between the suction bowl and the carrier ring, and the form-fitting locking takes place between the suction bowl and the carrier ring, so that the intermediate ring only has to be designed in such a way that it can be connected to the suction bowl and the carrier ring in such a way that it is at least largely sealed, without, however, being integrated into the force flow between the suction bowl and the carrier ring. The form-fitting connection between the first interface on the suction bowl and the fourth interface on the carrier ring can be designed in the same way as in the previous embodiment, either as a snap-in connection or as a bayonet connection.

It is advantageous if the intermediate ring borders a perforated plate which is penetrated by a multiplicity of bores, which each have a cross-sectional area which is less than 5 percent of a cross-sectional area of an internal diameter of the intermediate ring. The perforated plate, in a manner similar to the vacuum channels arranged at the bottom of the cup, serves to enable the vacuum to be distributed as homogeneously as possible over the object to be handled. Furthermore, the perforated plate has the task of limiting deformation of the object to be handled in order to avoid damage to the object to be handled. This applies in particular to the case where sensitive food or plastic bags are to be lifted and set down with the suction cup.

Preferably, the axial end region of the carrier ring and the sealing ring are designed to form a latching connection having a latching groove that runs at least in part around the circumference and is recessed in the radial direction and a latching projection that runs at least in part around the circumference and projects in the radial direction, or the sealing ring is fixed to the axial end region of the carrier ring in a materially bonded manner by means of an axially oriented end face. The way in which the sealing ring is attached to the carrier ring depends essentially on the material selected for the sealing ring. It is preferable for the sealing ring to be made of an elastomeric material, in particular silicone or acrylonitrile-butadiene rubber, or of a foam material, in particular of a polyurethane or a chloroprene rubber which is also sold under the name Neoprene, or an ethylene-propylene-diene rubber. For a sealing ring made of silicone, a snap-in connection can be selected; for a sealing ring made of NBR or foam, a material-locking connection is preferred.

It is advantageous if a circumferential sealing ring is arranged between a circumferential surface of the suction bowl and an oppositely arranged circumferential surface of the intermediate ring and/or that an O-ring is arranged between a circumferential surface of the intermediate ring and an oppositely arranged circumferential surface of the carrier ring. This measure increases the sealing effect between the suction bowl and the intermediate ring and between the carrier ring and the intermediate ring, so that the requirements for the dimensional accuracy of the peripheral surfaces can be reduced, since the O-ring ensures a certain tolerance compensation.

### BRIEF DESCRIPTION OF THE DRAWINGS

Advantageous embodiments of the invention are shown in the drawings.

FIG. 1 shows a perspective view of a first embodiment of a suction cup comprising a suction bowl, an intermediate ring, a carrier ring and a sealing ring,

FIG. 2 shows a sectional front view of the suction bowl according to FIG. 1,

FIG. 3 shows a sectional front view of the intermediate ring according to FIG. 1,

FIG. 4 shows a sectional front view of the support ring according to FIG. 1,

FIG. 5 shows a sectional front view of the sealing ring according to FIG. 1,

FIG. 6 shows a sectional perspective exploded view of the components of the suction cup according to FIG. 1, and

FIG. 7 shows a sectional perspective exploded view of a second embodiment of a suction cup.

### DETAILED DESCRIPTION

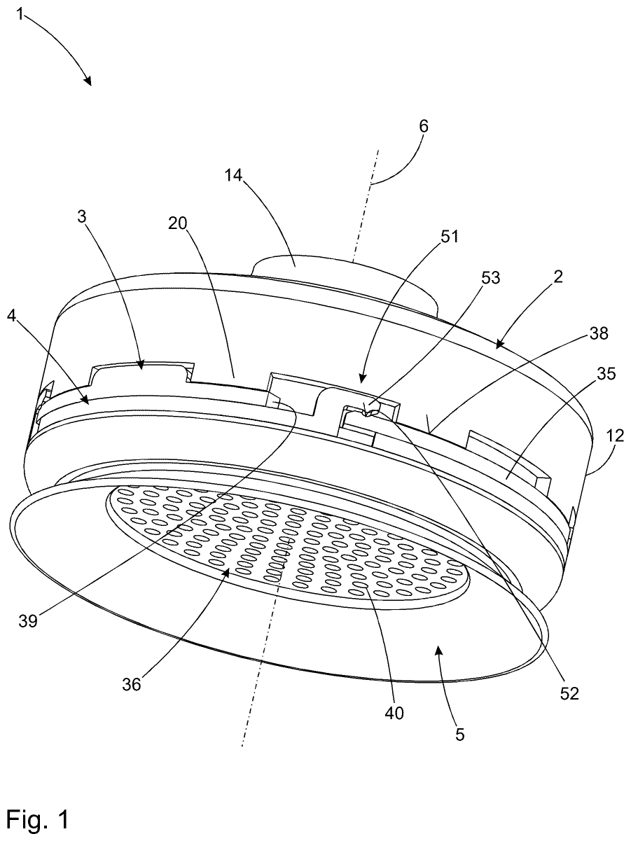

A suction cup 1 shown in FIG. 1 is intended for use with a handling device, which may be, for example, a robot arm of an industrial robot or a multi-axis handling system constructed from linear axes. Suction cup 1 is used to adhere to a handling object, which can be lifted with the handling device at one location and moved to another location and set down there by means of the adhering suction cup 1. For this purpose, a vacuum is provided at a vacuum connection 14 of the suction cup 1, by means of which a temporary suction of the suction cup 1 to a surface of a handling object can be effected. To release the suction cup 1 from the handling object, it may be possible to briefly provide a slight overpressure via the vacuum connection 14, whereby the suction cup 1 can be released from the handling object.

The suction cup 1 is of modular design to allow adaptation to different operating conditions, in particular different handling objects. The suction cup 1 comprises the components: suction bowl 2, intermediate ring 3, carrier ring 4, sealing ring 5. The components of the suction cup 1 are arranged along a bowl axis 6, which also may be named as the axial direction. By way of example, it is envisaged that the components of the suction cup 1, apart from a few minor exceptions, are rotationally symmetrical about the bowl axis 6. Furthermore, it is envisaged that the components of the suction cup 1, with the exception of the sealing ring 5, which may in particular be made of an elastomeric material such as silicone or NBR, are made of materials that, when the suction cup 1 is used as intended, undergo no or at least no significant elastic or plastic deformation and can therefore be described as dimensionally stable. It is preferably envisaged that the suction bowl 2, the intermediate ring 3 and the carrier ring 4 are each designed as plastic parts, which are manufactured in a plastic injection molding process or in an additive manufacturing process, in particular laser sintering.

As can be seen from the representation in FIG. 1, a bayonet connection 51 is formed between the carrier ring 4 and the intermediate ring 3, so that the carrier ring 4 with the sealing ring 5 attached to it can be easily removed from the intermediate ring 3 by a user, preferably without the use of tools, and can be replaced by another carrier ring 4 with a sealing ring 5. The bayonet connection 51 is formed by a third interface 52, referred to as an axial undercut, on the intermediate ring 3 and a supporting projection, supported on the latter and designed purely exemplarily in an L-shaped manner as a fourth interface 53, on the carrier ring 4, and is described in more detail below.

The intermediate ring 3 is fixed to suction bowl 2 in a form-fitting manner in the axial direction along the bowl axis 6 by means of a latching connection 61, which is described in more detail below. The sealing ring 5 is fixed to the carrier ring 4 in a form-fitting manner in the axial direction along the bowl axis 6 by means of a latching connection 81, which is described in more detail below.

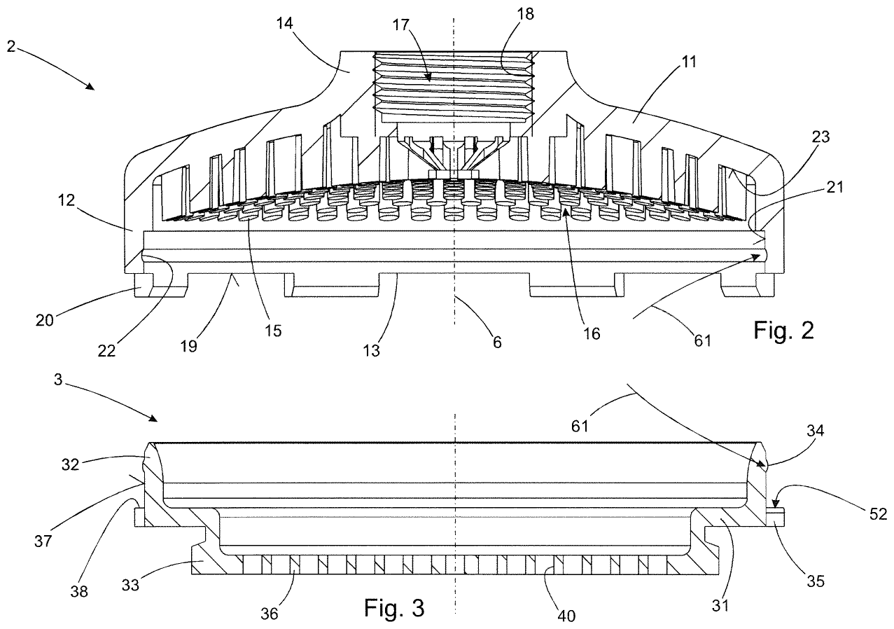

As can be seen from the sectional views in FIGS. 2 and 3, the suction bowl 2 has a bowl bottom 11, which is designed purely exemplarily in the form of a conical segment and is provided in a central region with the vacuum connection 14 aligned coaxially with the bowl axis 6. The vacuum connection 14 is exemplary configured as a tubular connecting piece which bounds a connection bore, referred to as a fluid bore 17, which is provided with an internal thread 18. This allows the vacuum connection 14 to be screwed to a connection nozzle of a handling device whereby both a mechanical fixing to the handling device and a vacuum supply from the handling device to the suction cup 1 are made possible.

A bowl wall 12 of essentially circular cylindrical design extends along the bowl axis 6 adjacent to the bowl bottom 11 and delimits a cup opening 13 at an end region facing away from the bowl bottom 11. Protrusions 20, which are aligned in the axial direction, project in the shape of a circular ring segment from an axial end face 19, which is designed in the shape of a circular ring, of the bowl wall 12 and are provided for a mechanical interaction with the intermediate ring 3, which will be described in more detail below. Furthermore, the bowl wall 12 is provided, on a purely exemplary circular cylindrical circumferential inner surface, also referred to as the first interface 21, with a radially outwardly extending latching groove 22, which is also configured for a mechanical interaction with the intermediate ring 3, described in more detail below. The radial extent of the latching groove 22 is chosen such that, when the suction bowl 2 is manufactured by a plastic injection molding process and the suction bowl 2 is demolded along the bowl axis 6, no slide in the injection mold is required.

Furthermore, a plurality of projections 15 extend in the axial direction along the bowl axis 6 from an inner surface 23 of the bowl bottom 11, which projections 15 are spaced apart from one another in such a way that they delimit vacuum channels 16. These vacuum channels 16 are in fluid communication with the fluid bore 17, so that when a vacuum is applied to the fluid bore 17, a vacuum supply to all vacuum channels 16 is ensured. The projections 15 are designed purely exemplarily as pins with a circular cross-section and are each aligned parallel to the bowl axis to favor production of the suction bowl 2 in a plastic injection molding process.

The intermediate ring 3 comprises a base body 31 in the form of a circular ring, from which a coupling ring 32 extends in the axial direction upwards and a second coupling ring 33 extends in the axial direction downwards, as shown in FIGS. 2 and 3. The first coupling ring 32 has a circular cylindrical outer circumferential surface, referred to as the second interface 37, from which a circumferential latching projection 34 extends in the radial direction outwards. The second interface 37 is adapted to the first interface 21 of suction bowl 2 in such a way that when the first coupling ring 32 is inserted into the cup opening 13 of the suction bowl 2, an at least substantially fluid-tight coupling is formed between these two components. Furthermore, the locking groove 22 of the first interface 21 of the suction bowl 2 and the locking projection 34 of the intermediate ring 3 are matched to one another in such a way that the locking projection 34 can be accommodated in a form-fitting manner in the locking groove 22, thereby ensuring an axially form-fitting locking mechanism between the suction bowl 2 and the intermediate ring 3.

The intermediate ring 3 has an annular collar 35 that extends in a radial direction outwards from the outer circumferential surface, referred to as the second intersection 37, of the first coupling ring 32. The annular collar 35 is provided with interruptions 39 that enable the supporting projection, referred to as the fourth intersection 53 and arranged on the carrier ring 4, to be mounted. An axially aligned, circular ring segment-shaped upper side 38 of the ring collar 35 forms the axial undercut 52, against which the supporting projection, designated as the fourth interface 53, of the carrier ring 4 comes to rest, as shown in FIG. 1.

As a purely exemplary example, the second coupling ring 33 of the intermediate ring 3 is provided at its end with a perforated plate 36 which extends over almost the entire cross-section of the intermediate ring 3 and which is provided with a multiplicity of bores 40. The perforated plate 36 serves to distribute the vacuum that can be provided via the vacuum connection 14 as homogeneously as possible and limits deformation of the handling object.

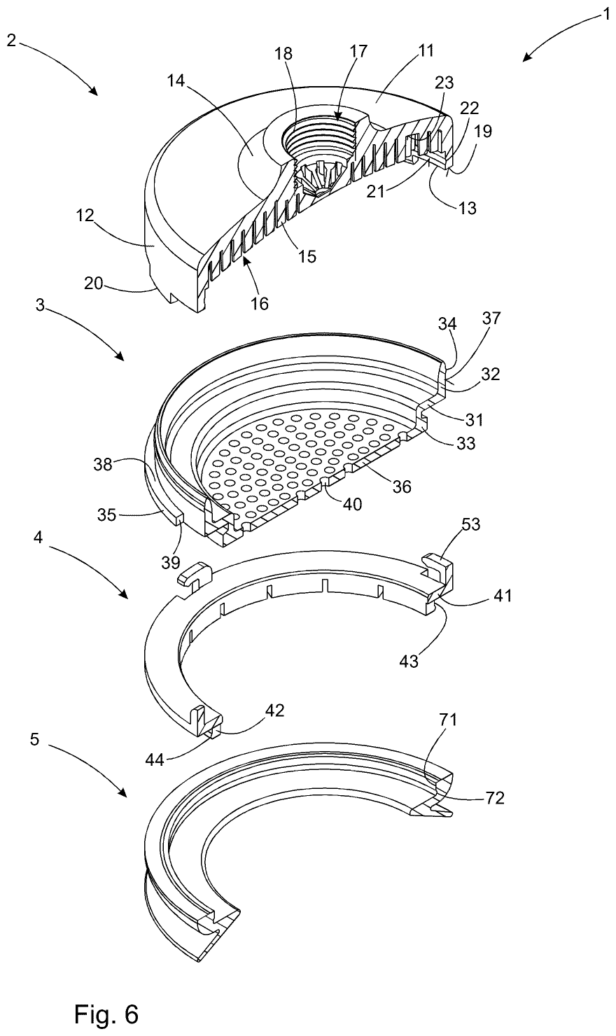

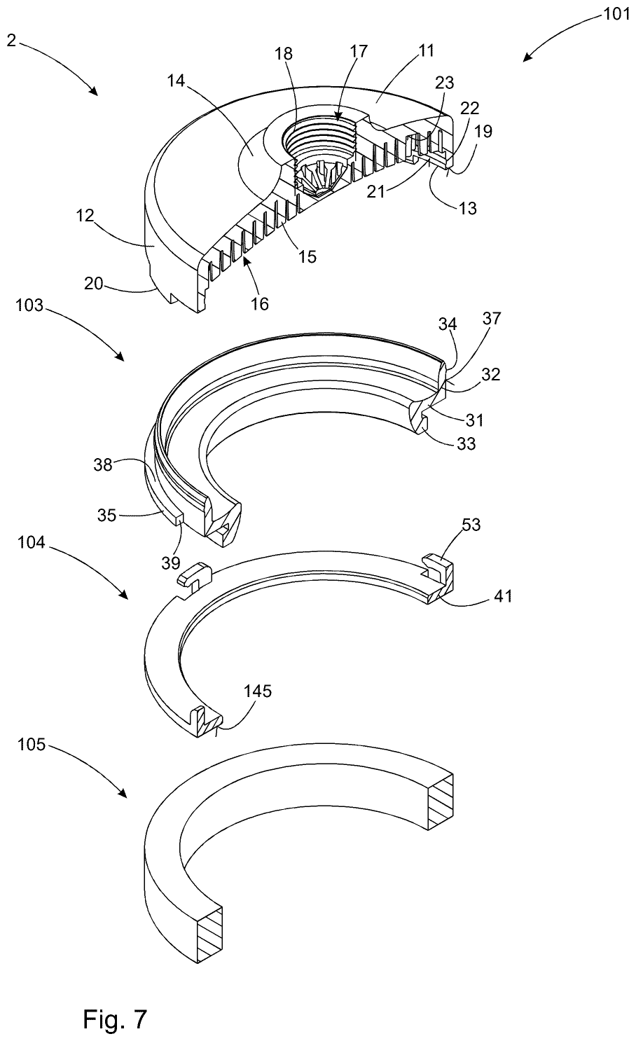

The carrier ring 4 also has a circular base body 41, from which, according to the illustrations in FIGS. 1 to 6, the fourth interfaces 53, for example arranged in a 90-degree division and designed as supporting projections, project upwards in the axial direction. This allows the carrier ring 4 to be locked in a form-fitting manner with respect to the intermediate ring 3 about the bowl axis 6 by means of a linear approach movement along the bowl axis 6 towards the intermediate ring 3 and a subsequent rotational movement.

Furthermore, starting from the base body 41, a coupling ring 42 extends downwards in the axial direction and has an outer circumferential surface 43, from which a latching projection 44 protrudes in the radially outward direction. The sealing ring 5 has a circumferential latching groove 72 on an inner surface 71, which is designed as a circular cylinder purely by way of example, which is intended for engagement by the latching projection 44 of the carrier ring 4 in order to form a latching connection 81.

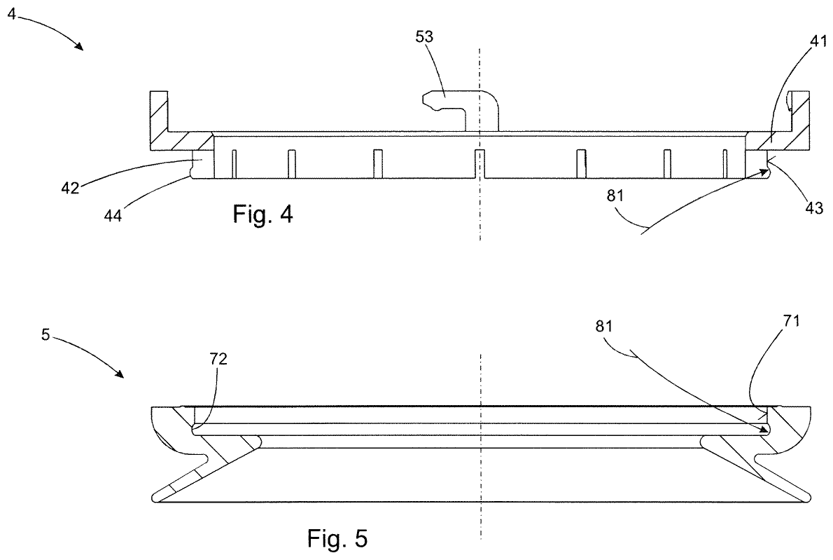

The embodiment of the suction cup 101 according to FIG. 4 differs with regard to the design of the intermediate ring 103, the carrier ring 104 and the sealing ring 105, so that the following description focuses exclusively on these two components, while a description of the suction bowl 2, which is identical to the first embodiment according to FIGS. 1 to 6, can be dispensed with.

In contrast to the design of the intermediate ring 3 according to FIGS. 1 to 6, the intermediate ring 103 has no perforated plate. The intermediate ring 103 can also be used without other changes in the first embodiment according to FIGS. 1 to 6 instead of the intermediate ring 3.

In deviation from the design of the carrier ring 4 according to FIGS. 1 to 6, the carrier ring 104 has a circular-ring-shaped underside 145, which is provided for a material-locking fixing of the sealing ring 105, which is designed in a purely exemplary manner in a circular ring shape. By way of example, it is envisaged that the sealing ring 105 is glued to the underside 145 of the carrier ring 104, in particular using a double-sided adhesive tape or a curable liquid adhesive.

The combination of the support ring 104 and the sealing ring 105 can also be used directly with the suction bowl 2 and intermediate ring 3 components according to FIGS. 1 to 6 without the need for further modifications.

1. A suction cup for a handling device, with a suction bowl which is provided with a vacuum connection at a bowl bottom and is connected to an intermediate ring at a bowl mouth, the intermediate ring being provided at an axial end region which faces away from the suction bowl with a carrier ring and the carrier ring being provided at an axial end region which faces away from the intermediate ring with a sealing ring for a sealing contact with a handling object;
wherein a plurality of vacuum channels are formed on an inner surface of the bowl bottom of the suction bowl, which vacuum channels are connected to a connection bore of the vacuum connection and which vacuum channels are bounded by a multiplicity of projections which are arranged at a distance from one another and project in an axial direction.

2. (canceled)

3. The suction cup according to claim 1, wherein the suction bowl has a first interface at the bowl mouth and the intermediate ring is provided with a second interface and with a third interface at mutually opposite axial end regions, wherein the second interface is coupled to the first interface of the suction bowl and wherein the carrier ring is provided at one axial end region with a fourth interface which is coupled to the third interface of the intermediate ring.

4. The suction cup according to claim 3, wherein the first interface and the second interface and/or the third interface and the fourth interface provide a form-fitting connection from the group: latching connection having a latching groove which is recessed in the radial direction and having a latching projection which projects in the radial direction; bayonet connection having an axial undercut and a supporting projection for axial support on the axial undercut.

5. The suction cup according to claim 1, wherein the suction bowl has a first interface at the bowl mouth and wherein the intermediate ring is received between the suction bowl and the carrier ring, wherein the carrier ring is provided at one axial end region with a fourth interface for coupling to the first interface of the suction bowl, the first interface and the fourth interface forming a form-locking connection from the group: latching connection having a latching groove which runs around at least part of the circumference and is recessed in the radial direction and having a latching projection which runs around at least part of the circumference and projects in the radial direction; bayonet connection having an axial undercut and a supporting projection for axial support on the axial undercut.

6. The suction cup according to claim 1, wherein the intermediate ring borders a perforated plate which is penetrated by a multiplicity of bores, wherein each of the bores has a cross-sectional area which is less than 5 percent of a cross-sectional area of an internal diameter of the intermediate ring.

7. The suction cup according to claim 1, wherein the axial end region of the carrier ring and the sealing ring form a latching connection having a latching groove which is recessed in the radial direction and has a latching projection which projects in the radial direction, or wherein the sealing ring is fixed in a materially secure manner to the axial end region of the carrier ring by means of an axially aligned end face.

8. The suction cup according to claim 1, wherein the sealing ring is made of an elastomeric material, in particular silicone or acrylonitrile-butadiene rubber, or a foam, in particular a polyurethane or a chloroprene rubber or an ethylene-propylene-diene rubber.

9. The suction cup according to claim 1, wherein a peripheral sealing ring is arranged between a circumferential surface of the suction bowl and an oppositely arranged circumferential surface of the intermediate ring and/or wherein a peripheral sealing ring is arranged between a circumferential surface of the intermediate ring and an oppositely arranged circumferential surface of the carrier ring.
